(19) United States
(12) Patent Application Publication
(10) Pub. No.: US 2008/0159757 A1
(43) Pub. Date: Jul. 3, 2008

(54) Receiver For Optical Communications, Comprising a Nonlinear Equaliser

(75) Inventors: Josep Prat Goma, Barcelona (ES); Pierluigi Poggiolini, Torino (IT)

Correspondence Address: BERENBAUM, WEINSHIENK & EASON, P.C, 370 17TH STREET, SUITE 4800, DENVER, CO, 80202, US

(73) Assignee: UNIVERSITAT POLITECNICA DE CATALUNYA, BARCELONA (ES)

(21) Appl. No.: 11/816,817

(22) PCT Filed: Feb. 20, 2006
(86) PCT No.: PCT/ES2006/000074

§ 371 Date: Oct. 18, 2007

(30) Foreign Application Priority Data
Feb. 21, 2005 (ES) P200500415

(51) Int. Cl. H04B 10/06

(52) U.S. Cl. 398/214

(57) ABSTRACT

The present development includes a first element of an optical fibre entrance by which an information carrying signal is transmitted, an optical detector block, a non-linear equalizer block and a final processor block. The development includes an electrical non-linear equalizer block, connecting the output of the optical detector block and the input of the final processor block that compensates the quadratic non-linear characteristic of the optical detector block. Both blocks thus may present a more linear joint characteristic between the electrical field envelope of the information carrying signal in the optical fibre and the electrical signal. Consequently, the final processor block can compensate, in a more effective form, for the linear distortions that the information carrying signal suffers in the transmission through the fibre. The result may be an optical receiver with non-linear compensation of the photo-detection process and with approximate linear compensation of the linear distortions of the optical fibre transmission.

The present development relates to a receiver for optical communications with a first element of an optical fibre entrance, through which an information signal is transmitted, an optical detection block, a non-linear equalizer block, and a final processor block.

### BACKGROUND

Due to progress in the fields of laser beams and of optical fibres, communication systems with optical fibres as transmission channels are possible, and depend fundamentally on the characteristics of light.

A communication system with an optical fibre, may have an emission block, also called emitter or optical transmitter, that has the ability to transform an information electrical signal into an information signal in light form; a transmission channel of this light, i.e. an optical fibre; and a reception or receiver block, that has the ability to transform the received optical information into information in the form of an electrical signal. The reception block with or without other devices may be called an optical receiver. It may be further noted that the emitter contains a light source that can be, for example, a laser diode or a light-emitting-diode (LED), whereas the optical receiver contains an optical detector that can be, for example, a photodiode (PIN or APD) or photo-transistor. Both emitter and receiver contain connectors that may allow them to be connected to the optical fibre and to each other.

In the field of optical receivers, direct detection optical receivers are typical and homodyne or heterodyne detection optical receivers are also known.

The architecture of the direct detection optical receivers is based primarily on a photo-detector and some circuits of amplification and processing of the signal. Thus, the receiver converts an optical signal into an electrical signal with current and voltage proportional to the input optical power, and that signal is then processed.

The transmission or propagation of the optical signal through the optical fibre channel, between the optical transmitter and the receiver, may give rise to issues of distortion, either or both linear and nonlinear, as well as noise and interference. Among the linear distortions are chromatic dispersion, which degrades the detected signal because some wavelengths travel faster than others. This spreads the digital pulses and, therefore corrupts the communication when the length of the fibre link and the bandwidth surpass the limits for the required detection quality. Such are described for example in “Fiber Optic Communication Systems” of Govind P. Agrawal, of John Wiley & Son publishers.

Several methods of compensation and minimization of the negative effects of these linear distortions have been developed, by means of optical compensators or equalizers, or, lately, by means of electrical or electronic compensators or equalizers in the optical receiver system. The electrical compensators or equalizers present normally, minor compensation capacity but they have the advantage of being adaptive. Particularly, they can be reconfigured in order to automatically or semi-automatically adapt to different optical links, and can be less expensive thanks to digital signal processing technologies that can be operated at the high speeds of optical communication transmissions. Such methods have been explained in an updated form for example in the paper “OFC 2004 workshop on optical and electronic mitigation of impairments”, of T. Nielsen and S. Chandrasekhar, in the Journal of Lightwave Technology, volume 23, number 1, January 2005, pages 131 to 142. Some of these methods of equalization have been the subject of patent publications, like the “Optical transmission method and optical transmission device”, reference WO2004068747; where, the linear distortions of the optical connection are compensated by means of an optical Fourier transformer.

The compensation capability of the electrical equalizers of the linear distortions may be limited by the non-linear characteristic of the photo-detector of the optical receiver. This has been explained for example in “Electronic equalization for advanced Modulation formats in dispersion-limited systems” of V. Curri, R. Gaudino, R., A. Napoli, and P. Poggiolini, published in the IEEE Photonics Technology Letters, volume 16, number 11. November 2004, pages 2556 to 2558.

### BRIEF DESCRIPTION

An aspect of the present development may include addressing one or more of the limitations mentioned herein by adapting the electrical equalizer to better compensate the negative effects of linear distortion in the optical transmission through an optical fibre.

An optical communications receiver hereof may have a non-linear electrical equalizer block, which may be disposed between the optical detector and the final processor, the equalizer block compensating for the non-linear characteristic of the photo-detector between the electromagnetic optical field envelope and the electrical current produced by the photo-detector. This relationship is quadratic, i.e., the mathematical square function of the optical field envelope and, at the same time linear with the optical instantaneous power, which is proportional to the field envelope squared due to the quantum phenomenon of photon to electron conversion that takes place in the optical photo-detector.

The present development proposes the inclusion of an electronic non-linear equalizer block with an input-output relationship inverse to that of the photo-detector in terms of the optical envelope. This relationship is thus a square root function. Mathematically, the block may be defined as making the relationship between the input and the output signals: S3=k S2(^{1/2}), where k is a constant. This relation is theoretical and ideal, and the practical implementation of the block with electrical or electronic circuitry is not normally ideal or exact. However, it may approximate this function with reasonable precision. It is a block without memory, which does not have to perform a filtering function.

The inclusion of this non-linear equalizer block in the optical receiver after the photo-detector block may enhance the advantages of the electronic equalization system by compensating for linear distortions in the transmission. This may be performed in the final processor block which may use algorithms of signal processing technologies, analog or digital. These may include a transversal linear filter, a “feed-forward” equalizer, a “decision-feedback” equalizer, a “maximum likelihood sequence estimator”, or combinations of the foregoing among others. There may also be one or more or several delay and/or multiplier stages with configurable coefficients or weights.

These algorithms theoretically allow for compensation of any linear distortion and thus, potentially, mitigate or eliminate the negative effects of such distortion. However, the non-linear characteristics of the photo-detector may turn a linear distortion into a non-linear distortion which may also be mitigated.

Investigations of an optical receiver system hereof corroborate this advantage. Using the present development, a considerable increase in the maximum optical fibre link length may be obtained, by about a factor or two or more, depending on the conditions relative to an example not using the non-linear equalizer for a given final quality of the communication from the input of the optical transmitter to the output of the optical receiver.

The final electrical processor block may perform a signal processing with the purpose of optimizing the quality of the signal at the receiver output, self-adapting to the characteristics of the transmission link by compensating its impairments or perturbations. Generally unlike the non-linear equalizer block, this final processing block may have filtering elements or electrical memory, either analog or digital. This block may be highly diverse depending on the application and the technological complexity. Commonly, this block may be linear, but there may also exist more sophisticated versions that are non-linear and that demonstrate acceptable system operation. This block may be any of the types of equalizers, filters or adaptive decisors available. These may include analogue filters, “Feed-Forward equalizer” (FFE), “Decision-Feedback equalizer” (DFE) and “Maximum Likelihood Sequence Estimation” (MLSE). As for its implementation, it may be a linear or a non-linear processor, analogue or digital, including hardware or software decoders, iterative or not, such as those with “Reed-Salomon”, convolutional, turbo or low- density-parity-control (LDPC) codes, with sequence estimation techniques for maximum likelihood, sequential or iterative, with Viterbi or BCJR algorithms. It may or may not perform decision functions, possibly with an adaptive threshold. It may also be made up of combinations of the latter, and may also include a fixed analogue low-pass filter.

The optical receiver system may also have a decision element or regenerator, which may extract the digital information contained in the signal obtained at the output of the final processor block and turn it into digital data, usually in binary format. It may also be included in the final processor block.

The optical receiver may also use amplifier elements between the individual blocks, and at its input or output, to increase the signal level that has been attenuated along the propagation through the optical fibre. Also, it may use connectors, cables and other elements of interconnection or adaptation of the optical or electrical signals.

The communication channel may be, instead of the optical fibre, air or space, as in the so-called “Free Space Optics”.

### BRIEF DESCRIPTION OF DRAWINGS

For a better understanding of what has been described, a drawing is included, in which:

FIG. 1 is a block diagram of an optical communication receiver hereof. The detailed definition of the blocks of FIG. 1 is mainly functional: in a practical implementation, the specified functions may be grouped in one or more different ways.

### DETAILED DESCRIPTION

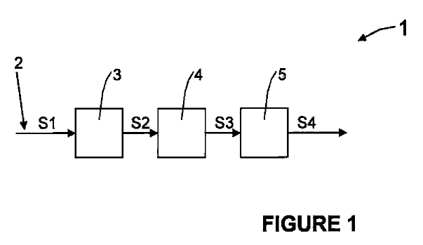

As can be seen in FIG. 1, the optical communication receiver 1 may have a first element of entrance of an optical fibre 2 by which an information carrying signal S1 may be transmitted, an optical detector block 3, a non-linear equalizer block 4 and a final processor block 5.

The optical signal S1 which may be a carrier of information, may be transmitted along the optical fibre 2 and may have originated at a remote optical transmitter (not shown). This signal S1 may be introduced into the optical photo-detector detector block 3, which may generate an electrical signal S2 that may be introduced into the non-linear equalizer block 4. This block 4 may generate, from S2, the S3 signal, which may be later equalized and filtered by the final processor block 5, which may generate the output signal S4.

The present development may include a non-linear equalizer block 4, which may produce a signal S3 that is proportional to the mathematical square root of its input signal S2.

There may be many possible implementations of this block that may approximate the non-linear input-output relationship described.

One implementation may be based on an electronic circuit that uses one or more non-linear semiconductor devices. It is not necessary that the non-linear function be fully implemented, but it may be sufficient that it be approximated in the margin of variation of the input signal S2.

The non-linear semiconductor device may be a field-effect-transistor (FET, JFET, MOSFET, MESFET or HEMT) that presents a quadratic-type relationship between the input voltage, i.e. between gate and source and the output current (i.e. at drain and source). If its operation is reversed, that is, if the transistor is feedback and is excited in current with a current source controlled by S2, and the produced voltage is sensed, the desired non-linear square root function may be obtained.

Another possible implementation may be based on a semiconductor diode. If it is current driven, with a current source, and the voltage is sensed, a logarithmic-type input-output relationship may be obtained. This may then be approximated, to some extent, to the square root function in an effective margin, appropriately choosing the adaptation resistor/s and the biasing current.

Other possible implementations may be digital, with mathematical operations or with a look-up table, to perform an approximation of the function per section or to combine diverse linear and nonlinear functions to approximate the ideal function, analogically or digitally. Also, other semiconductor devices such as the bipolar transistor (BJT) or others, may be used.

What is claimed is:

1. A receiver for optical communications that comprises: a first optical fibre input element to transmit an information carrying signal; an optical detector block adapted to receive the information carrying signal; a final processor block and a non-linear equalizer block, the non-linear equalizer block disposed between and operatively connected to the output of the optical detector block and the input of the final processor block; wherein the non-linear equalizer block adjusts the quadratic non-linear characteristics of the information carrying signal transmitted with the optical fibre input element and between the optical detector block and the final processor block and generates an electrical signal that is transmitted to the final processor block which generates a final processed signal which is more effectively compensated for the linear distortions that the information carrying signal suffered in the transmission through the optical fibre.

2. A receiver according to claim 1, wherein an amplifier is connected to the receiver or between or inside blocks thereof to increase the level of the signal that has been diminished in the transmission through the optical fibre.

3. A receiver according to claim 2, wherein the amplifier is electrical or optical.

4. A receiver according to claim 1, wherein the non-linear equalizer block has one or both of input-output relationship of the type of a root square mathematical function, or approximates the memory-less function.

5. A receiver according to claim 1, wherein the non-linear equalizer block is based on an electronic or electrical circuit that uses one or more non-linear semiconductor services.

6. A receiver according to claim 5, wherein the semiconductor device is of the field-effect-transistor type.

7. A receiver according to claim 5, wherein the semiconductor device is a diode.

8. A receiver according to claim 5, wherein the non-linear equalizer is implemented through the section approximation of the function or by combining diverse linear and non-linear functions to approximate the ideal function, and is made with linear and non-linear devices, analogically or digitally with a mathematical operation or a look-up table.

9. A receiver according to claim 8, wherein semiconductor devices are used.

10. A receiver according to claim 1, that uses one or more of connectors, cables or other elements of interconnection or adaptation of optical or electrical signals, before, after, or within the constituent blocks of the receiver.

11. A receiver according to claim 1, wherein the communication channel air or space.

12. A receiver according to claim 1, in which the information carrying signal contains a portion of unmodulated light.

13. A receiver according to claim 1, wherein the final processor block is substantially linear.

14. A receiver according to claim 1, in which the final processor block is based on “Maximum Likelihood Sequence Estimation” (MLSE) or, another known of adaptive decisor device that operates with received symbols, isolated or in sequence.

15. A reviver according to claim 1, in which the final processor block is a “Decision-Feedback Equalizer” (DFE) or, another known type of equalizer that optimizes the signal quality at the receiver output.

16. A receiver according to claim 1, in which the final processor block includes one or more known types of equalizers, filters, adaptive decisors or linear non-linear, analogue, or digital processors, including hardware or software decoders, iterative or non-iterative, with Reed-Salomon, convolutional, turbo or low-density parity-control (LDPC) codes, with sequence estimation techniques for maximum likelihood, sequential or iterative, with Viterbi or BCJR algorithms, and whereby the final processor block is adapted to implement one or more decision functions, one or more of which functions having an adaptive threshold.
